(19) United States
(12) Patent Application Publication
(10) Pub. No.: US 2024/0177065 A1
(43) Pub. Date: May 30, 2024

(54) MACHINE LEARNING DEVICE, DEGREE OF SEVERITY PREDICTION DEVICE, MACHINE LEARNING METHOD, AND DEGREE OF SEVERITY PREDICTION METHOD

(71) Applicant: Mitsubishi Electric Corporation, Chiyoda-ku, Tokyo (JP)

(72) Inventor: Ippei NISHIMOTO, Tokyo (JP)

(73) Assignee: Mitsubishi Electric Corporation, Chiyoda-ku, Tokyo (JP)

(21) Appl. No.: 18/551,201

(22) PCT Filed: Jun. 21, 2021
(86) PCT No.: PCT/JP2021/023298

§ 371 Date: Sep. 19, 2023

(51) Int. Cl. G06N 20/00; G06F 8/77

(52) U.S. Cl. CPC G06N 20/00; G06F 8/77

(57) ABSTRACT

An object of the present disclosure is to provide a machine learning device, a degree of severity prediction device, and a machine learning method capable of accurately predicting the degree of severity based on a situation. The machine learning device according to the present disclosure includes a learning unit configured to learn a degree of severity of problem solving for a target component item based on a data set that associates determination data regarding a risk of the target component item with a problem that has occurred in software development and state variables regarding the risk.

### TECHNICAL FIELD

The present disclosure relates to a machine learning device and a machine learning method for learning a degree of severity of risks in software development, a degree of severity prediction device provided with the machine learning device, and a degree of severity prediction method.

### BACKGROUND ART

In software development, progress meetings are conducted to grasp the progress of development tasks. In the progress meeting, the engineering process, the management process, and the support process in software development are checked to see if those processes are being executed as planned for the project. If any problem is identified at the progress meeting, the Work Breakdown Structure (WBS) of the project is required to be updated along with countermeasures for the problem.

In recent years, projects have seen an increase in the number of work packages within the WBS and an increase in complexity between the work packages. As a result, extracting work packages affected by problem solving from the WBS and updating them as necessary, requires a significant amount of time.

Methods of progress meetings include, for example, inspection, walk-through, team review, round-robin review, pass-around, peer review, and the like. The stakeholders of the project adopt these methods to conduct progress meetings.

Conventionally, techniques related to traceability management have been disclosed (for example, see Patent Document 1). In Patent Document 1, a management ID is assigned to deliverables. The management ID is accompanied by trace information. The trace information is registered in a traceability ID recording terminal.

Also, conventionally, techniques related to machine learning using Artificial Intelligence (AI) have been disclosed (for example, see Patent Document 2). In Patent Document 2, the learning method of state variables, determination data, and instructional data through supervised learning is disclosed.

### PRIOR ART DOCUMENTS

### Patent Document(s)

[Patent Document 1] Japanese Patent Application Laid-Open No. 2018-5802
[Patent Document 2] Japanese Patent Application Laid-Open No. 2017-188030

### SUMMARY

### Problem to be Solved by the Invention

Automotive SPICE (registered trademark, hereinafter the same) is a standard for process improvement in vehicle system development. Automotive SPICE demands stakeholders to create a WBS of the project, a list of component items, a list of change requests, a list of problem information, and a list of risk information. Further, Automotive SPICE requires an operation in which stakeholders to secure bidirectional traceability by linking a plurality of various contents of WBS, component items, change requests, problem information, and risk information.

Further, Automotive SPICE requires an operation in which a review of the affected WBS, component items, change requests, problem information, and risk information is conducted in the event of any problems arising during the progress meeting of the project. However, the method of reviewing this information by experts depends much on the skills of the experts involved. Furthermore, to conduct the review within a limited time frame, setting a degree of severity acquired by analyzing a degree of significance, a degree of consequence, and a degree of urgency of risks resulting from implementation of problem solving is required, yet it is left to the skills of the experts. Furthermore, reviewing changes in the WBS, component items, change requests, problem information, and risk information resulting from implementation of problem solving using bidirectional traceability within a limited time frame is challenging.

Meanwhile, in recent years, with the increasing complexity and sophistication of software development, the factors leading to problems have also become more complex. Consequently, despite utilizing bidirectional traceability and conducting progress meetings with experts, making prediction of degree of severity of risks is becoming more and more difficult.

As such, in a method relying on the skills of some experts to predict the degree of severity, actual situation is not sufficiently addressed or accuracies thereof are compromised. Therefore, there is a demand for a technique that enables accurate prediction of degree of severity based on a situation. This problem also arises in software development other than Automotive SPICE-compliant software development.

The present disclosure is made to solve such problems, and an object thereof is to provide a machine learning device, a degree of severity prediction device, a machine learning method, and a degree of severity prediction method capable of accurately predicting the degree of severity depending on a situation.

### Means to Solve the Problem

In order to solve the problem described above, the machine learning device according to the present disclosure includes a learning unit configured to learn a degree of severity of problem solving for a target component item based on a data set that associates determination data regarding a risk of the target component item with a problem that has occurred in software development and state variables regarding the risk.

### Effects of the Invention

According to the present disclosure, accurately prediction of the degree of severity depending on a situation is ensured.

The objects, features, aspects, and advantages of the present disclosure will become more apparent from the following detailed description and the accompanying drawings.

### BRIEF DESCRIPTION OF DRAWINGS

FIG. 1 A block diagram illustrating an example of a configuration of a degree of severity prediction system according to Embodiment 1.

FIG. 2 A flowchart illustrating an example of operation of the machine learning device according to Embodiment 1.

FIG. 3 A graph for describing an example of a pattern in which the degree of severity prediction system according to Embodiment 1 applies the degree of severity of each constituent item.

FIG. 4 A graph for describing an example of a pattern in which the degree of severity prediction system according to Embodiment 1 applies the degree of severity of each constituent item.

FIG. 5 A graph for describing an example of a pattern in which the degree of severity prediction system according to Embodiment 1 applies the degree of severity of each constituent item.

FIG. 6 A diagram illustrating an example of a configuration of a neural network.

FIG. 7 A block diagram illustrating an example of a configuration of a degree of severity prediction system according to Embodiment 2.

FIG. 8 A table illustrating an example of a data table of progress meeting agreement information.

FIG. 9 A graph for describing an example of a calculation method of degree of severity.

FIG. 10 A diagram illustrating an example of a hardware configuration of the machine learning device according to Embodiments.

FIG. 11 A diagram illustrating an example of a hardware configuration of the machine learning device according to Embodiments.

### DESCRIPTION OF EMBODIMENT(S)

### Embodiment 1

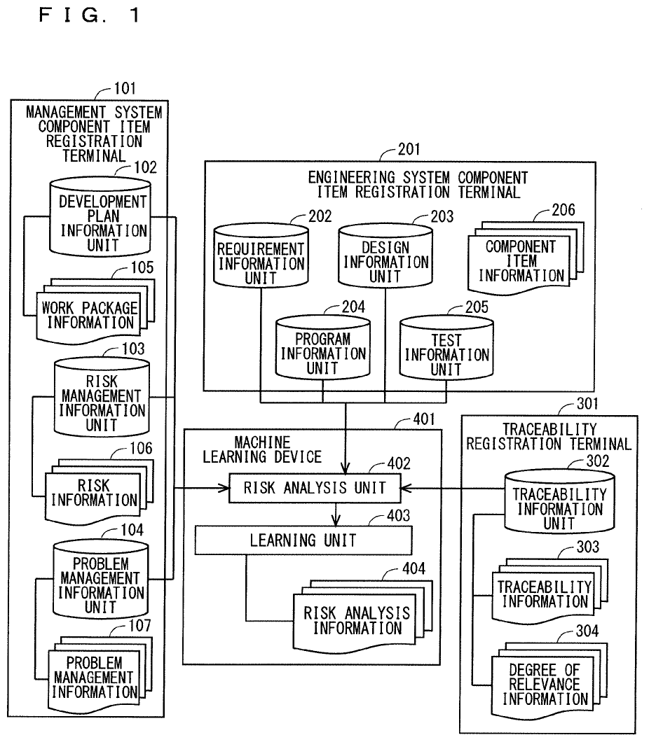

FIG. 1 is a block diagram illustrating an example of a configuration of a degree of severity prediction system according to Embodiment 1, illustrating only the essential components.

As illustrated in FIG. 1, the degree of severity prediction system according to Embodiment 1 includes a management system component item registration terminal 101, an engineering system component item registration terminal 201, a traceability registration terminal 301, and a machine learning device 401. Note that the management system component item registration terminal 101, the engineering system component item registration terminal 201, and the traceability registration terminal 301 may be combined arbitrarily and integrally configured.

Using the machine learning device 401 having a machine learning function, the degree of severity prediction system associates work package information 105 registered in a development plan information unit 102, risk information 106 registered in a risk management information unit 103, and problem management information 107 registered in a problem management information unit 104 of the management system component item registration terminal 101 with component item information 206 registered in each of a requirement information unit 202, a design information unit 203, a program information unit 204, and a test information unit 205 of the engineering system component item registration terminal 201 by traceability information 303 and degree of relevance information 304 registered in a traceability information unit 302 of the traceability registration terminal 301, learns the degree of severity of problem solving for a target component item, and acquires a prediction model. Also, based on the result of learning by the machine learning device 401, the degree of severity prediction system creates risk analysis information 404 indicating the pass or fail of registered risk manifestation result or the degree of severity of problem solving.

The risk analysis information 404 includes the risk information 106 registered in the risk management information unit 103 of the management system component item registration terminal 101 or information indicating the degree of severity of problem solving of the problem management information 107 registered in the problem management information unit 104. Note that the risk analysis information 404 may include information indicating the risk information 106 and the degree of severity of problem solving of the problem management information 107.

Also, the risk analysis information 404 may include a method of indicating that the risk manifestation result is in a normal state. Here, the risk analysis information 404 indicates the possibility of risk manifestation due to implementation of problem solving, and for example, either the maximum value or the minimum value thereof may be restricted. The risk analysis information 404 may be a continuous quantity or a discrete quantity.

Hereinafter, in a case where the risk information 106 registered in the risk management information unit 103 of the management system component item registration terminal 101 or the degree of severity of problem solving of the problem management information 107 registered in the problem management information unit 104 is predicted. However, it goes without saying that the contents of the present disclosure can be similarly applied to any other management system component item registration terminal 101.

The management system component item registration terminal 101 includes the development plan information unit 102. The work package information 105 is registered in the development plan information unit 102. The work package information 105 includes WBS work packages including a technical process operation, a management process operation, and a support process operation.

The engineering system component item registration terminal 201 includes the requirement information unit 202, the design information unit 203, the program information unit 204 and the test information unit 205. The component item information 206 is registered in each information unit. The component item information 206 includes trace identifiers (hereinafter referred to as “trace IDs”) assigned to each of a plurality of component items, and the trace information associated with the trace IDs.

The component item information 206 includes requirement specifications presented by clients, deliverables created in each process of software development, and the like. The processes of software development include system designing, software designing, software detail designing, program production, the unit test, the software test, the system test, and the like. Deliverables include design specifications, source codes, test specifications, test reports, and the like. For example, the component item information 206 including requirement specifications is registered in the requirement information unit 202. In the design information unit 203, the component item information 206 including design specifications created in each of the system designing, the software designing, and the software detail designing is registered. In the program information unit 204, the component item information 206 including source codes created in the program production is registered. In the test information unit 205, the component item information 206 including the test specifications and the test reports created by each of the unit tests, the software tests, and the system tests.

The trace IDs included in the component item information 206 include request IDs assigned to the requirement specifications, design IDs assigned to design specifications, test IDs assigned to the test specifications and the test reports, and the like. A trace ID is assigned to identify a component item.

The traceability registration terminal 301 includes a traceability information unit 302. In the traceability information unit 302, the traceability information 303 and the degree of relevance information 304 are registered. The traceability information 303 includes the trace information. The trace information is information for tracing with other component items created in the software development process, and in particular, information for tracing between a component item to which a trace ID is assigned and another component item. Other component items desirably include component items created in at least one of an upstream process and a downstream process. However, the other component items need not necessarily include the component items created in the upstream process and the downstream process. Also, a trace ID with no assigned trace information may be included among a plurality of trace IDs. The degree of relevance information 304 includes the number of trace changes and the degree of relevance of the trace.

The machine learning device 401 includes a risk analysis unit 402 and a learning unit 403. The risk analysis unit 402 extracts the risk information 106 including a degree of urgency and the problem management information 107 from the risk management information unit 103 and the problem management information unit 104 of the management system component item registration terminal 101. In addition, the risk analysis unit 402 extracts the work package information 105 including change information of a degree of urgency, a degree of consequence, and a degree of significance from the development plan information unit 102. When the risk information 106 and the problem management information 107 are insufficient, the relevant risk items or problem management items may be manually registered.

Also, based on the extracted risk information 106 and problem management information 107, the risk analysis unit 402 extracts the component item information 206 including a degree of consequence from the requirement information unit 202, the design information unit 203, the program information unit 204, and the test information unit 205 of the engineering system component item registration terminal 201.

Further, the risk analysis unit 402 extracts the degree of significance derived from the trace information of each component item, based on the component item information 206 held by the engineering system component item registration terminal 201 and the traceability information 303 and the degree of relevance information 304 registered in the traceability information unit 302 of the traceability registration terminal 301.

In this manner, in the machine learning device 401, the risk analysis unit 402 acquires determination data indicating the degree of urgency, the degree of consequence, and the degree of significance. Also, the risk analysis unit 402 acquires state variables, which are change information in values of the degree of urgency, the degree of consequence, and the degree of significance over time. Note that the machine learning device 401 may acquire some of the state variables including functional elements without acquiring all thereof, or may acquire new state variables. The determination data includes the critical path of the target component item.

The learning unit 403 acquires a prediction model by learning the degree of severity of problem solving according to a data set created based on the combination of the degree of urgency, the degree of consequence, and the degree of significance input from the risk analysis unit 402 and their state variables.

Here, the data set is data in which state variables and determination data are associated with each other. For example, when a plurality of changes occur during the progress meeting, the changes of the degree of urgency, the degree of consequence, and the degree of significance of the target component item and other component items related to the target component item are enormous; therefore, to confirm that all component items involved in the changes have achieved the degree of urgency, the degree of consequence, and the degree of significance is difficult within a limited time with the skills of experts. Meanwhile, the degree of severity prediction system according to Embodiment 1 uses machine learning, for example, to set the degree of severity of functional elements related to changes by traceability. Consequently, the degree of severity of problem solving can be quantified, enabling the prediction of the degree of severity of problem solving more accurately.

The machine learning is used to learn to predict the degree of severity of problem solving in software development, and the machine learning device 401 that performs the machine learning may be, for example, a digital computer connected to the traceability registration terminal 301 via a network and separate from the engineering system component item registration terminal 201.

The machine learning device 401 may be built in the traceability registration terminal 301. In this case, the machine learning device 401 uses the processor of the traceability registration terminal 301 to perform machine learning. The machine learning device 401 may reside on a cloud server.

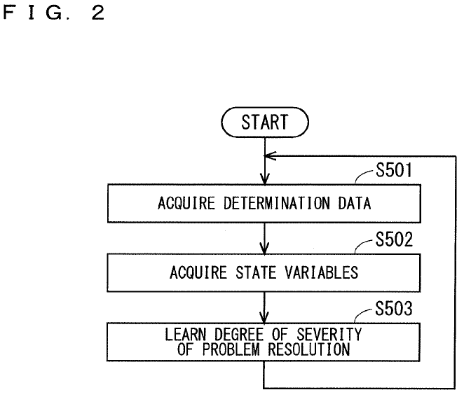

FIG. 2 is a flow chart illustrating an example of the operation (learning process) of the machine learning device 401. When the machine learning process starts, the machine learning device 401 executes Steps S501 to S503. Note that the processing order of Steps S501 and S502 may be reversed.

In Step S501, the risk analysis unit 402 acquires the determination data from the WBS work package corresponding to the target component item in the progress meeting.

In Step S502, the risk analysis unit 402 acquires state variables such as a degree of urgency, a degree of consequence, and a degree of significance regarding changes in the target component item in the progress meeting.

In Step S503, the learning unit 403 acquires a prediction model by learning the degree of severity of problem solving according to the data set created based on the combination of the determination data acquired in Step S501 and the state variables acquired in Step S502.

The processes of Steps S501 to S503 are repeatedly executed until, for example, the machine learning device 401 sufficiently learns the degree of severity of problem solving of the target component item. In this case, it is desirable to execute all patterns in which the degree of urgency, the degree of consequence, and the degree of severity of the target component item are changed a plurality times.

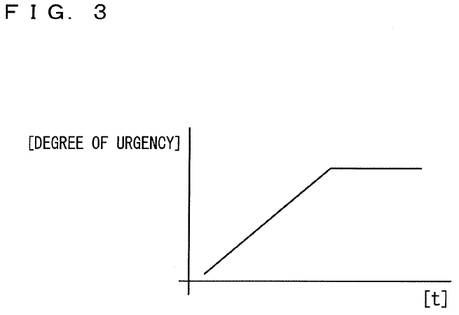

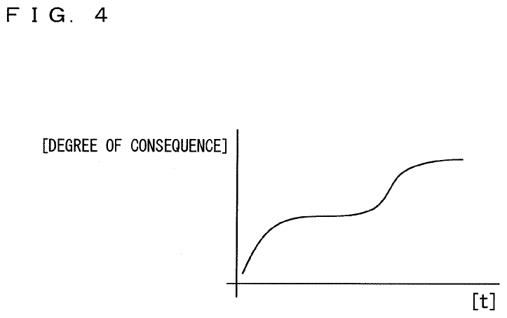

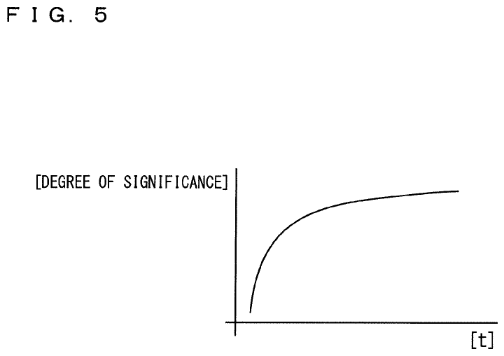

That is, the execution of a predetermined operation patterns as illustrated in FIGS. 3 to 5 correspond to project quality indices, and performing machine learning based on such project quality indices, enables to promote learning with conditions for the degree of severity of problem solving arranged. In addition, this also enables to exclude unintended data with a strong tendency to disperse as a waveform of the project quality indices, which limits the degree of severity of problem solving to characteristic motion, reducing in the data size.

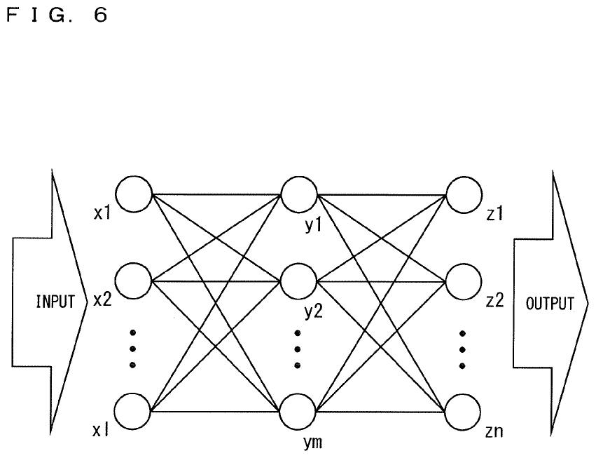

FIG. 6 is a diagram illustrating an example of a configuration of a neural network.

The risk analysis unit 402 in the machine learning device 401 may learn prediction of the degree of severity of problem solving according to, for example, the neural network model.

As illustrated in FIG. 6, the neural network includes an input layer containing 1 neuron(s) x1, x2, x3, . . . , x1, an intermediate layer (hidden layer) containing m neurons y1, y2, y3, . . . , ym, and an output layer containing n neurons z1, z2, z3, . . . , zn. Although only one intermediate layer is illustrated in the neural network, two or

more intermediate layers can be provided. Also, the machine learning device 401 (neural network) may use a general-purpose computer or processor, applying a large-scale Personal Computer (PC) cluster or the like enables faster processing.

The neural network learns the degree of severity of problem solving in the requirement information unit 202, the design information unit 203, the program information unit 204, and the test information unit 205 associated with the degree of severity of problem solving based on the degree of urgency, the degree of consequence, and the degree of significance of the management system component item registration terminal 101.

According to the degree of urgency, the degree of consequence, and the degree of significance created based on the combination of determination data acquired by the risk analysis unit 402, the neural network, learns, by so-called “supervised learning”, the relationship with the degree of severity of problem solving based on the degree of urgency, the degree of consequence, and the degree of significance, that is, prediction of the degree of severity of problem solving of the requirement information unit 202, the design information unit 203, the program information unit 204, and the test information unit 205. Here, “supervised learning” means that a large volume of sets of an input and result (label) is fed to the machine learning device 401 to have the device learn characteristics of the degree of urgency, the degree of consequence, and the degree of significance thereof, so that a model for estimation of a result from an input, that is the relationship thereof can inductively be acquired.

The neural network may also accumulate only when the degree of urgency, the degree of consequence, and the degree of significance of the requirement information unit 202, the design information unit 203, the program information unit 204, and the test information unit 205 of the engineering system component item registration terminal 201 normally satisfy the verification criteria, and learn by so-called “unsupervised learning” prediction of the degree of severity of problem solving in the requirements information unit 202, the design information unit 203, the program information unit 204, and the test information unit 205.

For example, when the degree of severity of problem solving in the requirement information unit 202, the design information unit 203, the program information unit 204, and the test information unit 205 of the engineering system component registration terminal 201 is extremely high, the “unsupervised learning” method is considered effective. Here, “unsupervised learning” is a method of learning how the input data is distributed by feeding a large volume of only input data to the machine learning device 401, and learning a device that performs compression, classification, shaping, etc. on the input data without being fed with the corresponding ground truth data.

It is possible to cluster the features from those validation results among similar ones, or the like. Using this result, output prediction can be achieved by setting some criteria and assigning outputs to optimize them. In addition, as an intermediate problem setting between “unsupervised learning” and “supervised learning”, there is also something called “semi-supervised learning”, where there are only some pairs of input and output data, and the others are only input data.

When predicting the degree of severity of problem solving, which will be described later, in response to the degree of urgency, the degree of consequence, and the degree of significance input to the input layer of the neural network, the output layer outputs information indicating whether or not the degree of severity of problem solving has been achieved, or the degree of severity of problem solving. It should be noted that the possible values of the “degree of severity of problem solving” may be any of a value with a limited maximum value or minimum value, a continuous quantity, or a discrete quantity.

According to the machine learning device 401 and the machine learning method according to the degree of urgency, the degree of consequence, and the degree of severity described above, a prediction model can be acquired by learning accurate progress management results according to the actual operational status. That is, even if the factors leading to the achievement of the degree of urgency, the degree of consequence, and the degree of significance are complicated and it is difficult to predict the degree of severity of problem solving in advance, the prediction of the degree of severity of problem solving can be performed with high accuracy.

When the risk analysis unit 402 acquires determination data indicating the degree of urgency, the degree of consequence, and the degree of significance from the management system component item registration terminal 101, depending on the length of time from the occurrence of the degree of urgency, the degree of consequence, and the degree of significance, to the acquisition of each determination data, the determination data may each be weighted to update the prediction of the degree of severity of problem solving. It is estimated that the shorter the time from the acquisition of the determination data to the result that satisfies the degree of urgency, the degree of consequence, and the degree of significance, the closer to a state where the risk or problem is to complete. Therefore, by weighting the determination data according to elapsed time from the occurrence of the degree of urgency, the degree of consequence, and the degree of significance, effective learning of the prediction of the degree of severity of problem solving described above is performable.

According to the degree of urgency, the degree of consequence, and the degree of significance created for a plurality of engineering system component item registration terminals 201, the risk analysis unit 402 may learn the prediction of the degree of severity of problem solving in the requirement information unit 202, the design information unit 203, the program information unit 204, and the test information unit 205. Also, the risk analysis unit 402 may acquire the degree of urgency, the degree of consequence, and the degree of significance from the plurality of engineering system component item registration terminals 201 used at the same software development site, in addition, the risk analysis unit 402 may learn the prediction of the degree of severity of problem solving using the degree of urgency, the degree of consequence, and the degree of severity collected from the plurality of engineering system component item registration terminals 201 that operate independently at different software development sites. Further, the engineering system component item registration terminal 201 for collecting the degree of urgency, the degree of consequence, and the degree of significance may be added to a target during software development, or conversely removed from a target during software development. That is, the learning unit 403 may relearn the degree of severity according to additional data sets based on the combination of the current determination data and state variables.

Next, the following three examples will be given as methods for sharing the verification results of the plurality of engineering system component item registration terminals 201, and it goes without saying that methods other than these methods can also be applied.

First, as a first example, following is a method of sharing neural network models so that they become the same. For example, for each weighting factor of the neural network, the difference between each engineering system component item registration terminal 201 is transmitted using communication means and reflected. That is, the learning unit 403 learns the degree of severity by weighting the determination data and comparing the normal state and the abnormal state of the determination data.

As a second example, following is a method of sharing machine learning weights and the like by sharing the validation results of the input and output of the neural network.

As a third example, following is a method of preparing a database, accessing the database, and loading a more appropriate neural network model to share the state (similar model).

### Embodiment 2

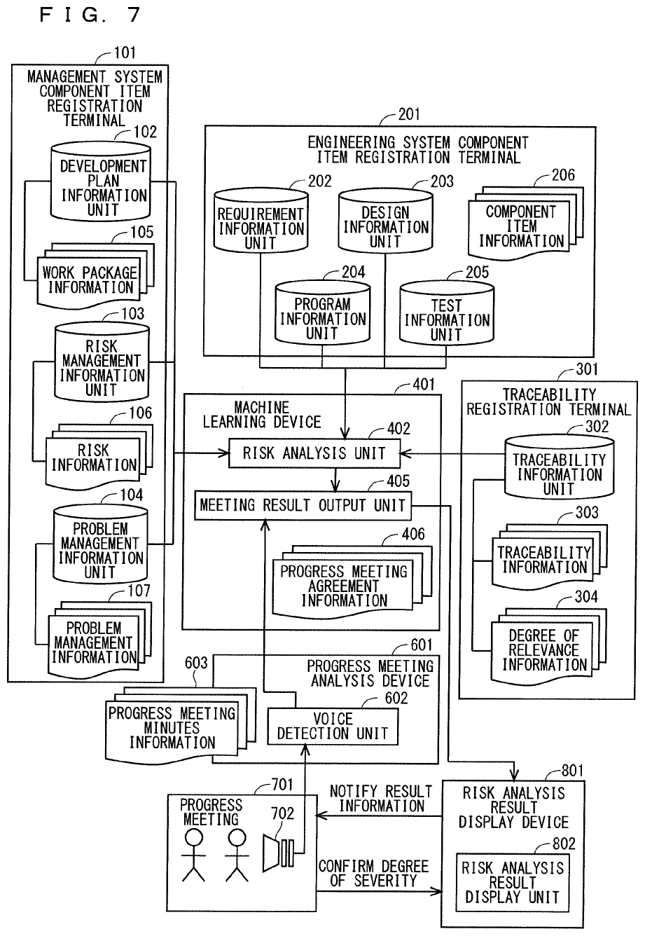

FIG. 7 is a block diagram illustrating an example of a configuration of a degree of severity prediction system according to Embodiment 2.

As illustrated in FIG. 7, the degree of severity prediction system according to Embodiment 2 includes a progress meeting analysis device 601 and a risk analysis result display device 801, in which the machine learning device 401 includes a meeting result output unit 405. Other configurations and basic operations are the same as those of the degree of severity prediction system of FIG. 1; therefore, detailed descriptions thereof are omitted here. The machine learning device 401, the progress meeting analysis device 601, and the risk analysis result display device 801 constitute a degree of severity prediction device.

The meeting result output unit 405 in the machine learning device 401 uses the results learned by the machine learning device 401 and outputs risks and problems that may occur due to changes in progress meeting activities.

The progress meeting analysis device 601 inputs the risks and problems of the progress meeting to the meeting result output unit 405 of the machine learning device 401 in real time. The progress meeting analysis device 601 includes a voice detection unit 602 that transcribes voice collected at a progress meeting 701.

The risk analysis result display device 801 outputs progress meeting agreement information 406 created by the meeting result output unit 405 of the machine learning device 401. The risk analysis result display device 801 includes a risk analysis result display unit 802 that displays the progress meeting agreement information 406.

The voice of the progress meeting 701 held at the progress meeting 701 is collected by the voice collection device 702 and input to the voice detection unit 602 of the progress meeting analysis device 601. The voice detection unit 602 analyzes the voice in the progress meeting 701 to create progress meeting minutes information 603 and outputs the progress meeting minutes information 603 to the meeting result output unit 405 of the machine learning device 401.

The meeting result output unit 405 of the machine learning device 401 acquires the degree of urgency, the degree of consequence, and the degree of significance associated with risks and problems for target component items and other related component items from the risk analysis unit 402.

Based on the degree of urgency, the degree of consequence, and the degree of significance associated with risks and problems, and a prediction model that has learned the degree of severity of problem solving from the progress meeting minutes information 603, the meeting result output unit 405 of the machine learning device 401 outputs the progress meeting agreement information 406 to the risk analysis result display device 801.

The progress meeting 701 receives the degree of urgency, the degree of consequence, and the degree of significance related to risks and problems by the prediction model that has learned the degree of severity of problem solving from the risk analysis result display device 801 in real time, thereby confirming the degree of severity of problem solving for the target component item.

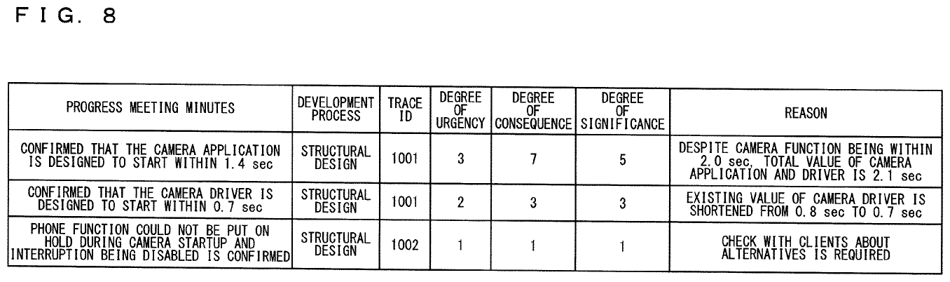

FIG. 8 is a table illustrating an example of a data table of the progress meeting agreement information 406 created by the meeting result output unit 504.

The progress meeting agreement information 406 includes the degree of urgency, the degree of consequence, and the degree of significance associated with risks and problems for the target component item and other related component items in the progress meeting 701.

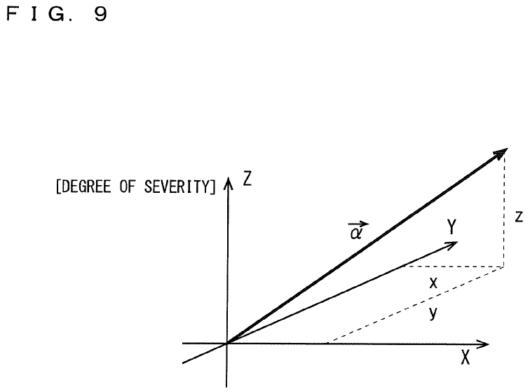

The following Expression (1) and FIG. 9 are an example of a method of calculating the degree of severity of problem solving.

[Expression 1]

|\vec{α}|(degree of severity of problem solving)=\sqrt{aₓ²+a_{y}²+a_{z}²} (1)

As a method of calculating the degree of severity of problem solving, there is a method of performing vector operations on individual degree of urgency, individual degree of consequence, and individual degree of significance. A threshold of the degree of severity of problem solving for a reasonable agreeable critical path for the progress meetings is derived from the number of risk manifestations that occur in lower processes and the number of problems that occur.

### <Hardware Configuration>

Each function of the risk analysis unit 402 and the learning unit 403 in the machine learning device 401 described in Embodiment 1 is implemented by a processing circuit. That is, the machine learning device 401 includes a processing circuit that acquires determination data indicating the degree of urgency, the degree of consequence, and the degree of significance, acquires the state variables, which are the change information in values of the degree of urgency, the degree of consequence, and the degree of significance over time, and acquires a prediction model by learning the degree of severity of problem solving according to a data set created based on the combination of the degree of urgency, the degree of consequence, and the degree of significance and their state variables. The processing circuit may be dedicated hardware, or a processor (a central processing unit (CPU), a processing unit, an arithmetic unit, a microprocessor, a microcomputer, a Digital Signal Processor (DSP)) implementing a program stored in a memory or the like.

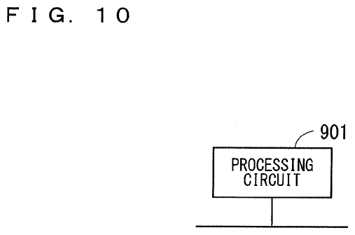

As illustrated in FIG. 10, when the processing circuit is the dedicated hardware, the processing circuit 901 corresponds to a single circuit, a composite circuit, a programmed processor, a parallel programmed processor, an Application Specific Integrated Circuit (ASIC), or a Field-Programmable Gate Array (FPGA), or the combination thereof. Each function of the risk analysis unit 402 and the learning unit 403 may be implemented by the processing circuit 901 respectively, or may be collectively implemented by one processing circuit 901.

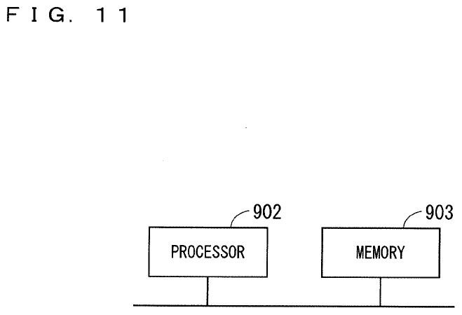

When the processing circuit 901 is a processor 902 illustrated in FIG. 11, each function of the risk analysis unit 402 and the learning unit 403 is implemented by software, firmware, or a combination of software and firmware. The software or the firmware are described as a program and stored in a memory 903. The processor 902 implements each function by reading and executing the program recorded in the memory 903. That is, the machine learning device 401 includes the memory 903 for storing the program which, eventually, executes a step of acquiring determination data indicating the degree of urgency, the degree of consequence, and the degree of significance, acquires the state variables, which are the change information in values of the degree of urgency, the degree of consequence, and the degree of significance over time, and a step of acquiring a prediction model by learning the degree of severity of problem solving according to a data set created based on the combination of the degree of urgency, the degree of consequence, and the degree of significance and their state variables. It can also be said that these programs cause the computer to execute the procedures or methods of the risk analysis unit 402 and the learning unit 403. Here, the memory may be, for example, a non-volatile or volatile semiconductor memory, such as a random access memory (RAM), a read only memory (ROM), a flash memory, an erasable programmable read only memory (EPROM), an electrically erasable programmable read only memory (EEPROM), or the like, a magnetic disk, a flexible disk, an optical disk, a compact disk, a digital versatile disc (DVD), or any storage medium used in the future.

As for each function of the risk analysis unit 402 and the learning unit 403, some functions may be implemented by dedicated hardware, and other functions may be implemented by software or firmware.

As described above, the processing circuit can implement the functions described above by hardware, software, firmware or the like, or a combination thereof. Although the hardware configuration of the machine learning device 401 illustrated in FIG. 1 has been described above, the same applies to the hardware configuration of the machine learning device 401 illustrated in FIG. 7.

It should be noted that Embodiments of the present disclosure can be arbitrarily combined and can be appropriately modified or omitted without departing from the scope of the invention.

While the present disclosure has been described in detail, the forgoing description is in all aspects illustrative and not restrictive. It is therefore understood that numerous undescribed modifications and variations can be devised.

### EXPLANATION OF REFERENCE SIGNS

101 management system component item registration terminal, 102 development plan information unit, 103 risk management information unit, 104 problem management information unit, 105 work package information, 106 risk information, 107 problem manage information, 201 engineering system component item registration terminal, 202 requirement information unit, 203 design information unit, 204 program information unit, 205 test information unit, 206 component item information, 301 traceability registration terminal, 302 traceability information unit, 303 traceability information, 304 degree of relevance information, 401 machine learning device, 402 risk analysis unit, 403 learning unit, 404 risk analysis information, 405 meeting result output unit, 406 progress meeting agreement information, 601 progress meeting analysis device, 602 voice detection unit, 603 progress meeting minutes information, 701 progress meeting, 702 voice collection device, 801 risk analysis result display device, 802 risk analysis result display unit, 901 processing circuit, 902 processor, 903 memory.

1. A machine learning device comprising:
a processor to execute a program, and
a memory to store the program which, when executed by the processor, performs process of,
learning a degree of severity of problem solving for a target component item based on a data set that associates determination data regarding a risk of the target component item with a problem that has occurred in software development and a state variable regarding the risk.

2. The machine learning device according to claim 1, wherein
the determination data includes a critical path of the target component item.

3. The machine learning device according to claim 1, wherein
the determination data includes trace information indicating a relationship between the target component item and other component items, and a degree of urgency, a degree of consequence, and a degree of significance between the component items.

4. The machine learning device according to claim 1, wherein
the determination data includes risk information of the component items and problem management information.

5. The machine learning device according to claim 1, wherein
the learning includes to learn the degree of severity by weighting the determination data and comparing a normal state and an abnormal state of the determination data.

6. The machine learning device according to claim 1, wherein
the learning includes to acquire the determination data via a network.

7. A degree of severity prediction device comprising:
the machine learning device according to claim 1; and
a risk analysis result display device configured to output the degree of severity for the current state variable based on a learning result of the machine learning device.

8. The degree of severity prediction device according to claim 7, wherein
the learning includes to re-learn the degree of severity according to an additional data set based on a combination of the current determination data and the current state variable.

9. The degree of severity prediction device according to claim 7, wherein
the machine learning device resides on a cloud server.

10. The degree of severity prediction device according to claim 7, wherein
the machine learning device is built in a traceability registration terminal.

11. The degree of severity prediction device according to claim 7, wherein
the degree of severity output by the risk analysis result display device is shared in a plurality of progress meetings held to grasp progress of the software development.

12. The degree of severity prediction device according to claim 11, further comprising
a progress meeting analysis device configured to collect voice of participants in each progress meeting and output the voice to the machine learning device.

13. A machine learning method comprising
learning a degree of severity of problem solving for a target component item based on a data set that associates determination data regarding a risk of the target component item with a problem that has occurred in software development and state variables regarding the risk.

14. A degree of severity prediction method comprising:
learning a degree of severity of problem solving for a target component item based on a data set that associates determination data regarding a risk of the target component item with a problem that has occurred in software development and state variables regarding the risk; and
outputting the degree of severity for the current state variable based on a learning result.
